(19) United States
(12) Patent Application Publication
(10) Pub. No.: US 2026/0167654 A1
(43) Pub. Date: Jun. 18, 2026

(54) PLANT CELL WALL-DISSOLVING AGENT

(71) Applicant: Kanazawa University, Kanazawa-shi (JP)

(72) Inventor: Kosuke KURODA, Kanazawa-shi (JP)

(73) Assignee: Kanazawa University, Kawaguchi-shi (JP)

(21) Appl. No.: 19/129,553

(22) PCT Filed: Nov. 17, 2023
(86) PCT No.: PCT/JP2023/041466

§ 371 Date: May 13, 2025

(30) Foreign Application Priority Data
Nov. 18, 2022 (JP) 2022-185119

(51) Int. Cl. C07F 9/6506; C08B 1/00

(52) U.S. Cl. CPC C07F 9/6506; C08B 1/003

(57) ABSTRACT

A low-toxic zwitterion capable of dissolving high concentrations of cellulose with the formula: R¹-A-R²—(OR³)n-B, where R¹ represents a C₁₋₈ linear alkyl group, a C₂₋₈ alkenyl group, or a C₁₋₈ linear-alkyl-(OCH₂CH₂)m-, A is a cationic moiety of the zwitterion and represents a cation selected from: imidazolium cation, phosphonium cation, ammonium cation, sulfonium cation, pyrazolium cation, pyridinium cation, pyrrolidinium cation, morpholinium cation, cyclopropenium cation, and piperidinium cation, R² represents an alkylene group having 1-4 carbon atoms, R³ represents an alkylene group having 2-4 carbon atoms, m represents a number of 1 or 2, n represents a number from 0-10, and B represents an anion selected from: —SO₃⁻, —COO—, —P═O(OR⁴)O⁻, and —OP═O(ORS)O⁻, wherein R⁴ and R⁵ are the same or different and are each a hydrogen atom or an alkyl group having from 1-8 carbon atoms and optionally having a heteroatom (provided that when n=0, B is —P═O(OR⁴)O⁻ or —OP═O(OR⁵)O⁻)).

### TECHNICAL FIELD

The present invention relates to a plant cell wall-dissolving agent. In particular, the present invention relates to a plant cell wall-dissolving agent can be used as it is for culturing microorganisms, whereby it is not necessary to remove the dissolving agent from plant cell wall lysates.

### BACKGROUND ART

Plant biomass is an important raw material for biorefinery. Plant cell walls contain cellulose, hemicellulose, and lignin as main components. All of these components are robust, and their industrial use is not easy. Hydrolysis is an option for the industrial treatment of cell walls, but requires much energy; thus, there is an idea to liquefy cell walls.

A method using an ionic liquid has been reported as a means for liquefying plant cell walls (Non-Patent Literature 1). This ionic liquid can be used to dissolve cell walls; however, it is difficult to remove the ionic liquid from the lysate. Therefore, even after cellulose is extracted from the lysate and hydrolyzed to glucose, the ionic liquid remains as a component, which may adversely affect microbial fermentation when the resulting glucose is used.

Accordingly, the present inventor has found and reported that the use of a less-toxic ionic liquid (zwitterion) to dissolve cellulose can reduce the toxicity, whereby one-pot ethanol production can be carried out (Non-Patent Literature 2).

### CITATION LIST

### Non Patent Literatures

Non-Patent Literature 1: J. Phy. Chem. B. 118, 10444-10459 (2014)
Non-Patent Literature 2: J. Am. Chem. Soc. 139, 16052-16055 (2017)

### SUMMARY OF INVENTION

### Technical Problem

However, it has been found that when cellulose is dissolved using the zwitterion mentioned above, the viscosity of the solution increases, causing a problem of high concentrations of cellulose not being dissolved.

Therefore, the present invention is intended to develop a low-toxic zwitterion capable of dissolving high concentrations of cellulose.

### Solution to Problem

As a result of various studies in order to solve the above problems, the present inventor has found that a zwitterion having one or more oxyalkylene groups between the cationic and anionic moieties or a zwitterion having a phosphate cation as the cationic moiety, has low toxicity and can dissolve high concentrations of cellulose with low viscosity. Thus, the present invention has been completed.

That is, the present invention provides the following inventions [1] to [8].

[1] A zwitterion of formula (1):

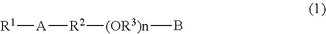

(R¹ represents a linear alkyl group having from 1 to 8 carbon atoms, an alkenyl group having from 2 to 8 carbon atoms, or a C₁₋₈ linear-alkyl-(OCH₂CH₂)m-,
A is a cationic moiety of the zwitterion and represents a cation selected from the group consisting of imidazolium cation, phosphonium cation, ammonium cation, sulfonium cation, pyrazolium cation, pyridinium cation, pyrrolidinium cation, morpholinium cation, cyclopropenium cation, and piperidinium cation,
R² represents an alkylene group having from 1 to 4 carbon atoms,
R⁵ represents an alkylene group having from 2 to 4 carbon atoms,
m represents a number of 1 or 2,
n represents a number from 0 to 10, and
B represents an anion selected from the group consisting of —SO₃⁻, —COO⁻, —P═O(OR⁴)O⁻, and —OP═O(OR⁵)O⁻, wherein R⁴ and R⁵ are the same or different and are each a hydrogen atom or an alkyl group having from 1 to 8 carbon atoms and optionally having a heteroatom (provided that when n is 0, B is —P═O(OR⁴)O⁻ or —OP═O(OR⁵)O⁻)).

[2] The zwitterion according to [1], wherein A in formula (1) is a cation selected from the group consisting of imidazolium cation, pyrazolium cation, pyridinium cation, pyrrolidinium cation, and piperidinium cation.

[3] The zwitterion according to [1] or [2], wherein A in formula (1) is imidazolium cation.

[4] The zwitterion according to any one of [1] to [3], wherein R¹ in formula (1) represents a linear alkyl group having from 1 to 4 carbon atoms, an alkenyl group having from 2 to 4 carbon atoms, or a C₁₋₄-alkyl-(OCH₂CH₂)m- (wherein m represents a number of 1 or 2).

[5] The zwitterion according to any one of [1] to [4], wherein n in formula (1) is a number from 1 to 6.

[6] The zwitterion according to any one of [1] to [5], wherein B in formula (1) is —COO⁻.

[7] The zwitterion according to any one of [1] to [4], n in formula (1) is a number from 0 to 6, and B is —P═O (OR⁴)O⁻ or —OP═O (OR⁵)O⁻.

[8] A plant cell wall-dissolving agent composition comprising the zwitterion according to any one of [1] to [7].

[9] A cellulose-dissolving agent composition comprising the zwitterion according to any one of [1] to [7].

[10] A method for dissolving cell walls of a plant, comprising a step of bringing a composition comprising the zwitterion according to any one of [1] to [7] into contact with the plant.

[11] A method for dissolving cellulose in a cellulose-containing plant, comprising a step of bringing a composition comprising the zwitterion according to any one of [1] to [7] into contact with the plant.

### Advantageous Effect of Invention

The zwitterion of the present invention is an ionic liquid, has the action of easily dissolving plant cell walls typified by high concentrations of cellulose, and has low toxicity. Therefore, the use of the zwitterion of the present invention to dissolve plant cell walls enables biorefinery of a large amount of plant biomass. For example, glucose, ethanol, and the like can be produced safely and industrially from plant biomass.

### BRIEF DESCRIPTION OF DRAWING

FIG. 1 illustrates the ¹H NMR chart of C₁imC₂P.

### DESCRIPTION OF EMBODIMENTS

An embodiment of the present invention is a zwitterion of formula (1):

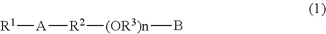

(R¹ represents a linear alkyl group having from 1 to 8 carbon atoms, an alkenyl group having from 2 to 8 carbon atoms, or a C₁₋₈ linear-alkyl- (OCH₂CH₂)m-,
A is a cationic moiety of the zwitterion and represents a cation selected from the group consisting of imidazolium cation, phosphonium cation, ammonium cation, sulfonium cation, pyrazolium cation, pyridinium cation, pyrrolidinium cation, morpholinium cation, cyclopropenium cation, and piperidinium cation,
R² represents an alkylene group having from 1 to 4 carbon atoms,
R³ represents an alkylene group having from 2 to 4 carbon atoms,
m represents a number of 1 or 2,
n represents a number from 0 to 10, and
B is an anionic moiety of the zwitterion and represents an anion selected from the group consisting of —SO₃⁻, —COO⁻, —P═O(OR⁴)O⁻, and —OP═O(OR⁵)O⁻, wherein R⁴ and R⁵ are the same or different and are each a hydrogen atom or an alkyl group having from 1 to 8 carbon atoms and optionally having a heteroatom (provided that when n is 0, B is —P═O(OR⁴)O⁻ or —OP═O(OR⁵)O⁻)).

In the present invention, the zwitterion is a molecule which has both positive and negative charges within one molecule. The zwitterion of the present invention has a cationic moiety indicated by A and an anionic moiety indicated by B. The zwitterion of the present invention has a feature of having one or more oxyalkylene groups between the cationic moiety indicated by A and the anionic moiety indicated by B. The cation and the anion can independently take free positions, the melting point decreases, and the viscosity decreases, since the zwitterion has one or more rotatable oxyalkylene structures between the cationic and anionic moieties. As the number of rotatable oxyalkylene structures between the cationic and anionic moieties, the number of repetitions n of the oxyethylene structure is from 1 to 10, preferably from 1 to 6, and more preferably from 1 to 3.

In the present invention, alkyl groups are saturated chain hydrocarbon groups and include linear and branched alkyl groups. Preferred are alkyl groups having from 1 to 8 carbon atoms, which include linear or branched alkyl groups having from 1 to 8 carbon atoms. More preferred are linear or branched alkyl groups having from 1 to 6 carbon atoms, and even more preferred are linear or branched alkyl groups having from 1 to 4 carbon atoms.

Specific examples of these alkyl groups include a methyl group, an ethyl group, an n-propyl group, an isopropyl group, an n-butyl group, an isobutyl group, a sec-butyl group, a tert-butyl group, an n-pentyl group, an n-hexyl group, an n-heptyl group, an n-octyl group, and the like.

In the present invention, alkenyl groups are unsaturated chain hydrocarbon groups having one double bond and include linear and branched alkenyl groups. Preferably, linear or branched alkenyl groups having from 2 to 8 carbon atoms are included. More preferred are linear or branched alkenyl groups having from 2 to 6 carbon atoms, and more preferred are linear or branched alkenyl groups having from 2 to 4 carbon atoms.

Specific examples of these alkenyl groups include a vinyl group, a 1-propenyl group, a 2-propenyl group (allyl group), a butenyl group, a pentenyl group, a hexenyl group, and the like.

In the present invention, alkylene groups are divalent saturated chain hydrocarbon groups and include linear and branched alkylene groups. Preferred are linear or branched alkylene groups having from 1 to 4 carbon atoms, and more preferred are linear or branched alkylene groups having from 2 to 4 carbon atoms. Specific examples thereof include a methylene group, an ethylene group, a trimethylene group, a propylene group, and a tetramethylene group.

R¹ represents a linear alkyl group having from 1 to 8 carbon atoms, an alkenyl group having from 2 to 8 carbon atoms, or a C₁₋₈ linear alkyl-(OCH₂CH₂)m-.

The linear alkyl group having from 1 to 8 carbon atoms is preferably a linear alkyl group having from 1 to 6 carbon atoms, and more preferably a linear alkyl group having from 1 to 4 carbon atoms.

Specific examples of these alkyl groups include a methyl group, an ethyl group, an n-propyl group, an n-butyl group, an isobutyl group, an n-pentyl group, an n-hexyl group, an n-heptyl group, an n-octyl group, and the like. Preferred among these are a methyl group, an ethyl group, an n-propyl group, an n-butyl group, an n-pentyl group, and an n-hexyl group; and more preferred are a methyl group, an ethyl group, an n-propyl group, and an n-butyl group.

Examples of the alkenyl group having from 2 to 8 carbon atoms include linear or branched alkenyl groups having from 2 to 8 carbon atoms. Preferred are linear or branched alkenyl groups having from 2 to 6 carbon atoms, and more preferred are linear or branched alkenyl groups having from 2 to 4 carbon atoms. Preferred among these are a vinyl group, a propenyl group, a butenyl group, a pentenyl group, and a hexenyl group; and more preferred are a vinyl group, a 1-propenyl group, a 2-propenyl group (allyl group), and a butenyl group.

The C₁₋₈ linear alkyl group in the group of the C₁₋₈ linear alkyl-(OCH₂CH₂)m- is preferably a linear alkyl group having from 1 to 6 carbon atoms, and more preferably a linear alkyl group having from 1 to 4 carbon atoms.

Specific examples of these alkyl groups include a methyl group, an ethyl group, an n-propyl group, an n-butyl group, an isobutyl group, an n-pentyl group, an n-hexyl group, an n-heptyl group, an n-octyl group, and the like. Preferred among these are a methyl group, an ethyl group, an n-propyl group, an n-butyl group, an n-pentyl group, and an n-hexyl group; and more preferred are a methyl group, an ethyl group, an n-propyl group, and an n-butyl group.
m is a number of 1 or 2.

A is a cationic moiety of the zwitterion and represents a cation selected from the group consisting of imidazolium cation, phosphonium cation, ammonium cation, sulfonium cation, pyrazolium cation, pyridinium cation, pyrrolidinium cation, morpholinium cation, cyclopropenium cation, and piperidinium cation.

Preferred among these cations is imidazolium cation, ammonium cation, pyrazolium cation, pyridinium cation, pyrrolidinium cation, morpholinium cation, or piperidinium cation; more preferred is imidazolium cation, pyrazolium cation, pyridinium cation, pyrrolidinium cation, or piperidinium cation; and further more preferred is imidazolium cation.

R² represents an alkylene group having from 1 to 4 carbon atoms, which includes a linear or branched alkylene group having from 1 to 4 carbon atoms. Specific examples thereof include a methylene group, an ethylene group, a trimethylene group, a propylene group, and a tetramethylene group.

R³ is, for example, a linear or branched alkylene group having from 2 to 4 carbon atoms, and specific examples thereof include an ethylene group, a trimethylene group, a propylene group, and a tetramethylene group. Therefore, OR³ is preferably an oxyethylene group, an oxytrimethylene group, an oxypropylene group, or an oxytetramethylene group.

When the anionic moiety is —SO₃⁻ or —COO⁻, n is preferably a number from 1 to 10, more preferably from 1 to 8, further more preferably from 1 to 6, and even more preferably from 1 to 4. When the anionic moiety is —P═O(OR⁴)O⁻ or —OP═O(OR⁵)O⁻, n is preferably a number from 0 to 10, more preferably from 0 to 8, further more preferably from 0 to 6, and even more preferably from 0 to 4.

B is an anionic moiety of the zwitterion and represents an anion selected from the group consisting of —SO₃⁻, —COO—, —P═O(OR⁴)O⁻, and —OP═O(OR)O⁻, wherein R⁴ and R⁵ are the same or different and are each a hydrogen atom or an alkyl group having from 1 to 8 carbon atoms and optionally having a heteroatom.
R⁴ and R⁵ are preferably hydrogen atoms, methyl groups, ethyl groups, or the like.

Preferred among these is an anion selected from the group consisting of —COO—, —P═O(OR⁴)O⁻, and —OP═O(OR⁵)O⁻. When n is 0, —P═O(OR⁴)O⁻ or —OP═O(OR⁵)O⁻ is preferred.

Specific examples of the zwitterion of formula (1) include the compounds listed in Table 1 below.

TABLE 1

| R¹ | A | R² | (OR³)n | B |
|---|---|---|---|---|
| CH₃ | im | (CH₂)₂ | (OCH₂CH₂)₃ | COO⁻ |
| CH₃ | im | (CH₂)₃ | (OCH₂CH₂)₃ | COO⁻ |
| H₃C(OCH₂CH₂)₂ | im | (CH₂)₂ | (OCH₂CH₂)₃ | COO⁻ |
| H₃C(OCH₂CH₂) | im | (CH₂CH₂)₂ | (OCH₂CH₂)₃ | COO⁻ |
| H₃C(OCH₂CH₂)₂ | im | (CH₂CH₂)₂ | (OCH₂CH₂)₂ | COO⁻ |
| H₅C₂ | im | (CH₂CH₂)₂ | (OCH₂CH₂)₃ | COO⁻ |
| H₇C₃ | im | (CH₂CH₂)₂ | (OCH₂CH₂)₃ | COO⁻ |
| H₁₁C₅ | im | (CH₂CH₂)₂ | (OCH₂CH₂)₃ | COO⁻ |
| H₅C₂(OCH₂CH₂)₂ | im | (CH₂CH₂)₂ | (OCH₂CH₂)₃ | COO⁻ |
| CH₃ | im | (CH₂)₂ | (OCH₂CH₂)₃ | OP═O(OH)O⁻ |
| H₃C(OCH₂CH₂)₂ | im | (CH₂)₂ | (OCH₂CH₂)₃ | OP═O(OH)O⁻ |
| CH₃ | im | (CH₂)₂ | (OCH(CH₃)CH₂)₃ | COO⁻ |
| H₃C(OCH₂CH₂)₂ | im | (CH₂)₂ | (OCH(CH₃)CH₂)₃ | COO⁻ |
| CH₂═CHCH₂ | im | (CH₂)₂ | (OCH₂CH₂)₃ | COO⁻ |
| CH₂═CH | im | (CH₂)₂ | (OCH₂CH₂)₃ | COO⁻ |

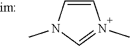

The zwitterion of formula (1) can be produced, for example, in accordance with the following reaction formula.

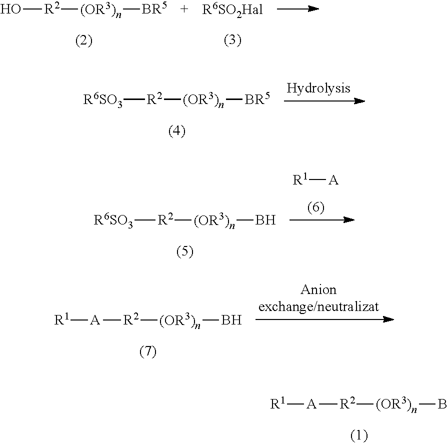

(wherein R⁵ represents an alkyl group or an aromatic hydrocarbon group, R⁶ represents an alkyl group, a halogenoalkyl group, or an aromatic hydrocarbon group, and A, B, R¹, R², R³, and n are as defined above.)

R⁵ represents an alkyl group or an aromatic hydrocarbon group. Examples of the alkyl group include linear or branched alkyl groups having from 1 to 8 carbon atoms. Specifically, a methyl group, an ethyl group, and a tert-butyl group are more preferred. Examples of the aromatic hydrocarbon group include a phenyl group, a halogenophenyl group, a nitrophenyl group, and the like.

R⁶ represents an alkyl group, a halogenoalkyl group, or an aromatic hydrocarbon group. Examples of the alkyl group include linear or branched alkyl groups having from 1 to 8 carbon atoms. Specifically, a methyl group, an ethyl group, and the like are more preferred. Examples of the halogenoalkyl group include a fluoroalkyl group. Specific examples thereof include a trifluoromethyl group and the like. Examples of the aromatic hydrocarbon group include an alkylphenyl group and the like. Specific examples thereof include a p-toluene group.

In (Formula 4), the hydroxyl group is substituted with a leaving group for performing a nucleophilic substitution reaction in a subsequent reaction. Although a typical leaving group is shown here, it may be replaced by another leaving group, such as halogen.

Each step of the above reaction formula will be described.

Step (1) is a step of reacting a compound (2) with a compound (3) to obtain a compound (4) This step is to sulfonylate the hydroxy group of the compound (2).

The compound (3) is a sulfonylating agent and is preferably a sulfonyl halide compound such as tosyl chloride, mesyl chloride or trifluoromethylsulfonyl chloride.

This reaction is preferably performed in the presence of a base. The base to be used includes tertiary amines such as triethylamine and 4-dimethylaminopyridine and inorganic bases such as sodium hydroxide, potassium hydroxide and sodium bicarbonate.

The reaction may be performed in a solvent at a temperature of from 0° C. to 100° C. for from about 1 hour to 40 hours. The solvent to be used includes halogenated hydrocarbons such as dichloromethane, aromatic hydrocarbons such as benzene and toluene, ethers, acetonitrile, and other versatile solvents.

Step (2) is a step of hydrolyzing the compound (4) to obtain a compound (5).

A general hydrolysis reaction is used as this hydrolysis reaction. For example, an acid hydrolysis reaction using an acid such as hydrochloric acid, and a base hydrolysis reaction using sodium hydroxide, triethylammonium hydroxide, or the like are preferred.

For example, in the hydrolysis reaction using hydrochloric acid, a small amount of hydrochloric acid may be added to react at from 0° C. to 100° C. for from a few minutes to about 5 hours.

Step (3) is a step of reacting the compound (5) with a compound (6) to obtain a compound (7). This step is to perform a cationization reaction by binding the compound (6) to the compound (5).

This reaction may be performed in a solvent by stirring at from room temperature to about 200° C. for from about 1 hour to 20 hours. The solvent to be used includes halogenated hydrocarbons such as dichloromethane, aromatic hydrocarbons such as benzene and toluene, ethers, acetonitrile, and other versatile solvents.

Step (4) is a step of converting the compound (7) to a zwitterion. An anion exchange resin may be added for neutralization. The anion exchange resin can be an anion exchange resin having a quaternary ammonium group.

The zwitterion of formula (1) is liquid at room temperature, and is stable and does not decompose up to a temperature of 240° C. It has also been found that the zwitterion of formula (1) has low toxicity and a high ability to dissolve cellulose, which is the main component of plant cell walls and can dissolve high concentrations of cellulose. Therefore, the zwitterion of the present invention is useful as a plant cell wall-dissolving agent composition or a cellulose-dissolving agent composition.

When the zwitterion of the present invention is used as a plant cell wall-dissolving agent composition or a cellulose-dissolving agent composition, a liquid containing only the zwitterion of the present invention may be used as it is, or may be used in combination with other components. That is, the plant cell wall-dissolving agent composition or the cellulose-dissolving agent composition of the present invention may contain from 5 mass % to 100 mass % of the zwitterion of the present invention.

Other components which can be incorporated into the plant cell wall-dissolving agent composition or the cellulose-dissolving agent composition include other components which can dissolve cellulose and the like, such as an ionic liquid and LiCl/dimethylacetamide. Organic solvents which alone cannot dissolve cellulose can dissolve cellulose in the form of solvent mixtures; thus, potential candidates also include, for example, water, methanol, and dimethyl sulfoxide. In addition, various medium components can also be added.

In order to dissolve plant cell walls or cellulose using the plant cell wall-dissolving agent composition or cellulose-dissolving agent composition of the present invention, a composition containing the zwitterion of the present invention may be brought into contact with a plant or a cellulose-containing plant. Specifically, a plant may be added in a composition containing the zwitterion of the present invention and dissolved at from room temperature to 240° C.

The plant to be used includes plants which are expected to be used as plant biomass raw materials, and examples of such materials include wood chips, various plants, various plant wastes, agricultural residues, thinned wood, waste paper, disposable chopsticks, paper cups, wood, waste materials, and the like. Such materials are dissolved by using the plant cell wall-dissolving agent composition of the present invention, followed by necessary treatment, whereby they are expected to be used as, for example, ethanol, biodiesel, other industrial raw materials, and raw materials for useful substances.

For example, in order to produce ethanol from plant biomass, the plant biomass is pre-treated with the plant cell wall-dissolving agent composition of the present invention to dissolve cellulose and the like, and then cellulose is enzymatically hydrolyzed to glucose in accordance with a conventional method, followed by microbial fermentation, thereby obtaining ethanol. In general, it is difficult to remove highly polar and water-soluble substances, such as plant cell wall-dissolving agents. There is concern that if such substances remain, they may be toxic when enzymes or microorganisms are used in post-treatment. The plant cell-dissolving agent composition of the present invention has low toxicity to enzymes and microorganisms, allowing for a wider range of post-treatment options.

### EXAMPLES

Next, the present invention will be described in more detail with reference to Examples; however, the present invention is not limited to these Examples.

### (Nuclear Magnetic Resonance)

1H-NMR was measured using ECA 400 manufactured by JEOL Ltd. (external magnetic field: 400 MHz).

### (Fast-Atom Bombardment-Mass Spectrometry: FAB-MS)

Fast-atom bombardment-mass spectrometry was performed using a mass spectrometer, i.e., a double-focusing mass spectrometer JMS-700 manufactured by JEOL Ltd. and owned by Research Institute for Instrumental Analysis, Kanazawa University.

### (Sodium Concentration Meter)

Manufacturer: Daiki Rika Kogyo Co., Ltd. (HORIBA Compact Sodium Ion Meter)

Experimental method: A two-point calibration was performed in accordance with the instructions before use. The water layer after liquid separation was not concentrated, but was collected as it was, and dropped on the concentration meter for measurement.

### (Viscosity Measurement)

The viscometer used was Brookfield LVDV2TCP with a CPE52 spindle, or Brookfield RVDV2T with a CPE52 spindle.

### (DSC-60A Plus)

Manufacturer: Shimadzu Corporation

Experimental method: Under N₂ atmosphere, liquid nitrogen was used during cooling. After the temperature was increased at a rate of 10° C./min to 20° C. below the pyrolysis point starting at 25° C., two sets of “cooling to −100° C. at a rate of −10° C./min→heating to 20° C. below the pyrolysis point at a rate of 10° C./min” were repeated (holding time: 5 minutes for each stage), followed by cooling down to 25° C.

### (TG-DTA)

Manufacturer: Shimadzu Corporation, DTG-60A

Experimental method: Under N₂ atmosphere, the temperature was increased to 500° C. at a rate of 10° C./min starting at room temperature. The pyrolysis point was evaluated at the intersection of the tangent lines between the steady state and the decomposition.

### Synthesis Example 1 (Synthesis of C₁imC₂OE₃C (R¹═CH₃, A=Imidazolium Cation, R²═CH₂CH₂, R³═CH₂CH₂, n=3, and B=—COO⁻))

### [Raw Materials]

benzenesulfonyl chloride, p-toluenesulfonyl chloride, 1-methylimidazole, sodium hydroxide and diethyl ether were purchased from Tokyo Chemical Industry Co., Ltd. Toluene, dichloromethane, MeOH, chloroform-di, and 99.8 atom % D with 0.03 vol % TMS were purchased from Kanto Chemical Co., Inc. Tetrahydrofuran with stabilizer and hydrochloric acid were purchased from FUJIFILM Wako Pure Chemical Corporation. Aluminum oxide (active, basic, Brockmann 1) was purchased from Sigma-Aldrich. Amberlite IRN-78, ion exchange resin and nuclear grade was purchased from Alfa Aesar. Tert-butyl 12-hydroxy-4,7,10-trioxadodecanoate was purchased from Accela ChemBio.

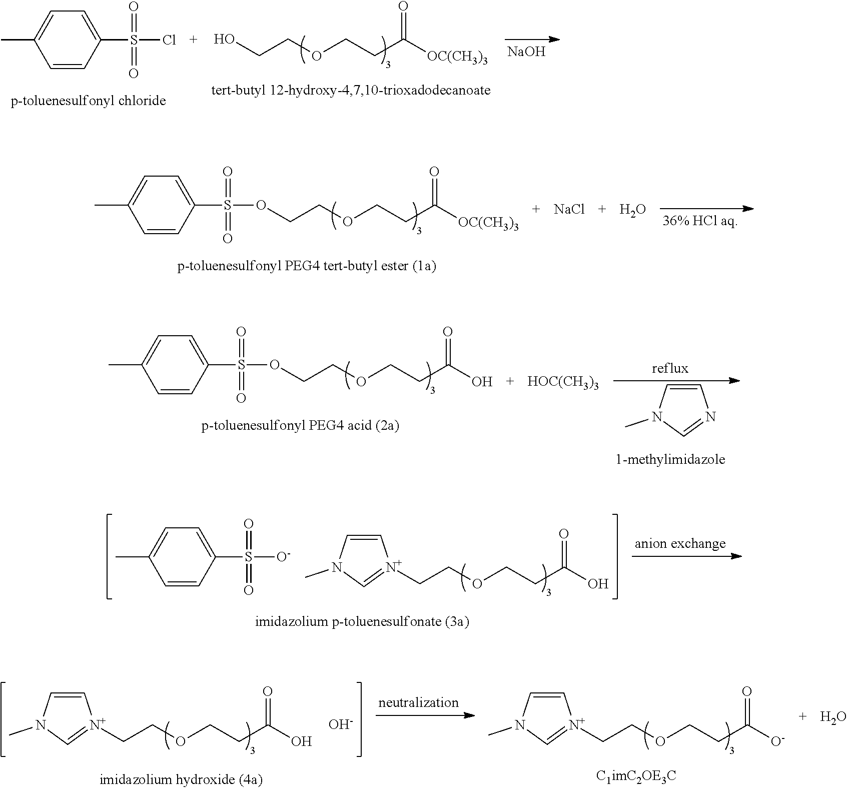

(1) Synthesis of p-Toluenesulfonyl PEG4 Tert-Butyl Ester (1a)

4.9 g of tert-butyl 12-hydroxy-4,7,10-trioxadodecanoate was placed in a 50 mL eggplant flask, and 30 mL of dichloromethane (DCM) was added for dissolution. Thereafter, the eggplant flask was cooled with ice, and 2.45 g of NaOH was added to 3.5 equiv. (molar equivalent) with respect to the tert-butyl 12-hydroxy-4,7,10-trioxadodecanoate, followed by stirring under ice-cooling. Further, 4.4 g of p-toluenesulfonyl chloride was gradually dropwise added to the eggplant flask under stirring under ice-cooling to 1.3 equiv. with respect to the tert-butyl 12-hydroxy-4,7,10-trioxadodecanoate. After dropping the entire amount, the resulting mixture was reacted by stirring at room temperature for 28 hours. After 28 hours of stirring, filter paper (5C, ADVANTEC) was used to remove solid impurities. The reaction solution containing the filtered product was placed in a liquid separation funnel and co-washed with 60 mL of DCM. Thereafter, water was added, the pH and sodium concentration of the water layer after liquid separation were measured, and the liquid separation operation was performed until the pH was 7 and the measured sodium concentration was 0 ppm. After liquid separation, the DCM layer was dried under reduced pressure to obtain a product. The structure of the product was confirmed by 1H NMR, and the product was used as the raw material for the next step without purification.

(2) Synthesis of p-Toluenesulfonyl PEG4 Acid (2a)

The synthesized p-toluenesulfonyl PEG4 tert-butyl ester was placed in a 200 mL eggplant flask, and 45 g of 36% HCl aq. was added to 25 equiv. with respect to the p-toluenesulfonyl PEG4 tert-butyl ester. The resulting mixture was reacted by stirring at room temperature for 3 hours. After 3 hours of stirring, the reaction solution containing the product was placed in a liquid separation funnel and co-washed with 120 mL of DCM. Thereafter, water was added, and the liquid separation operation was performed until the pH of the water layer after liquid separation was 7. After the liquid separation, the DCM layer was dried under reduced pressure to obtain a product. The structure of the product was confirmed by 1H NMR, and the product was used as the raw material for the next step without purification.

(3) Synthesis of Imidazolium p-Toluenesulfonate (3a)

The synthesized p-toluenesulfonyl PEG4 acid was placed in a 200 mL eggplant flask, and 20 mL of tetrahydrofuran purified with aluminum oxide (active, basic, Brockmann 1) was added for dissolution. Thereafter, the eggplant flask was cooled with ice, and 1.77 g of 1-methylimidazole was added, followed by stirring under ice-cooling. Then, the resultant was reacted by refluxing using a reflux condenser at 70° C. for 45 hours. After 45 hours of refluxing, the reaction solution was dried under reduced pressure, and diethyl ether was added to the 200 mL eggplant flask containing the resulting product for washing (40 mL, 4 h, 3 times). After washing, drying was performed under reduced pressure to obtain a product. The structure of the product was confirmed by 1H NMR, and the product was used as the raw material for the next step without purification.

(4) Synthesis of Imidazolium Hydroxide (4a) and C₁imC₂OE₃C

The synthesized imidazolium p-toluenesulfonate was dissolved in 600 mL of H₂O/MeOH (1/2: w/w) solvent, and the resulting mixture was transferred to a 1 L bottle. Thereafter, 35 mL of anion exchange resin (Amberlite IRN-78, exchange capacity: 1.1 eq/L) was added, followed by stirring at room temperature for 10 days to produce imidazolium hydroxide.

After anion exchange, filter paper (5C, ADVANTEC) was used to remove the anion exchange resin, and the reaction solution was transferred to a 20 mL eggplant flask. The resulting reaction solution was concentrated, and the neutralization reaction and the production reaction of C₁imC₂OE₃C were allowed to proceed. Thereafter, diethyl ether was added to the 20 mL eggplant flask containing the product for washing (20 mL, 1 day, 3 times). After washing, drying was performed under reduced pressure to obtain an oily product (purity: 98%). The yield from tert-butyl 12-hydroxy-4,7,10-trioxadodecanoate was 56%.

¹H NMR (400 MHz; CDCl₃; Me₄Si) 6=2.424 (2H, t, J=4.0 Hz, CH₂COO), 3.538-3.644 (8H, m, OCH₂CH₂OCH₂CH₂OCH₂CH₂COO), 3.790 (2H, t, J=11.6 Hz, NCH₂CH₂OCH₂), 3.919 (2H, t, J=9.6 Hz, NCH₂CH₂OCH₂), 3.980 (3H, s, CH₃N), 4.499 (2H, t, J=9.6 Hz, NCH₂CH₂O), 7.238 and 7.243 (1H, m, NCHCHN), 10.465 (1H, s, NCHN).

Mass spectrometry with fast atom bombardment ionization: in positive mode, m/z=287.1610 (M+H⁺, found) and 287.1607 (M+H⁺, calculated); and in negative mode, m/z=285.1452 (M−H⁺, found) and 285.1450 (M−H⁺) (calculated).

### Synthesis Example 2 (Synthesis of OE₂imC₂OE₃C (R¹═H₃C (OCH₂CH₂)₂, A=Imidazolium Cation, R²═CH₂CH₂, R³═CH₂CH₂, n=3, and B=—COO⁻))

### [Raw Materials]

Benzenesulfonyl chloride, p-toluenesulfonyl chloride, imidazole, diethylene glycol monomethyl ether, sodium hydroxide and diethyl ether were purchased from Tokyo Chemical Industry Co., Ltd. Toluene, dichloromethane, MeOH, chloroform-di and 99.8 atom % D with 0.03 vol % TMS were purchased from Kanto Chemical Co., Inc. Tetrahydrofuran with stabilizer and hydrochloric acid were purchased from FUJIFILM Wako Pure Chemical Corporation. Aluminum oxide (active, basic, Brockmann 1) was purchased from Sigma-Aldrich. Amberlite IRN-78, ion exchange resin and nuclear grade were purchased from Alfa Aesar. Tert-butyl 12-hydroxy-4,7,10-trioxadodecanoate was purchased from Angene International Limited.

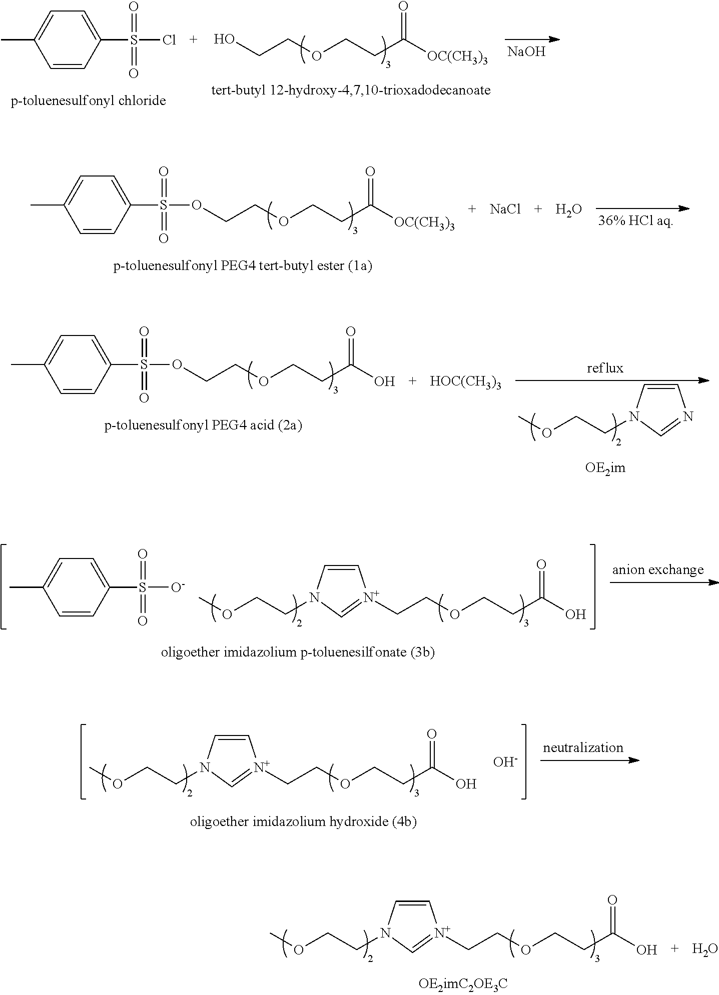

### (1) Synthesis of p-toluenesulfonyl PEG4 tert-butyl ester (1a)

3.72 g of tert-butyl 12-hydroxy-4,7,10-trioxadodecanoate was placed in a 50 mL eggplant flask, and 10 mL of DCM was added for dissolution. Thereafter, the eggplant flask was cooled with ice, and 3.38 g of NaOH was added to 6.2 equiv. (molar equivalent) with respect to the tert-butyl 12-hydroxy-4,7,10-trioxadodecanoate, followed by stirring under ice-cooling. Further, 3.3 g of p-toluenesulfonyl chloride was gradually dropwise added to the eggplant flask under stirring under ice-cooling to 1.3 equiv. with respect to the tert-butyl 12-hydroxy-4,7,10-trioxadodecanoate. After dropping the entire amount, the resulting mixture was reacted by stirring at room temperature for 17 hours. After 17 hours of stirring, filter paper (5C, ADVANTEC) was used to remove solid impurities. The reaction solution containing the filtered product was placed in a liquid separation funnel and co-washed with 60 mL of DCM. Thereafter, water was added, the pH and the sodium concentration of the water layer after liquid separation were measured, and the liquid separation operation was performed until the pH was 6 and the measured sodium concentration was 0 ppm. After the liquid separation, the DCM layer was dried under reduced pressure to obtain a product. The structure of the product was confirmed by 1H NMR, and the product was used in a subsequent reaction.

### (2) Synthesis of p-toluenesulfonyl PEG4 acid (2a)

The synthesized p-toluenesulfonyl PEG4 tert-butyl ester was placed in a 200 mL eggplant flask, and 34.4 g of 36% HCl aq. was added to 25 equiv. with respect to the p-toluenesulfonyl PEG4 tert-butyl ester. The resulting mixture was reacted by stirring at room temperature for 3 hours. After 3 hours of stirring, the reaction solution containing the product was placed in a liquid separation funnel and co-washed with 50 mL of DCM. Thereafter, water was added, and the liquid separation operation was performed until the pH of the water layer after the liquid separation became 7. After the liquid separation, the DCM layer was dried under reduced pressure to obtain a product. The structure of the product was confirmed by 1H NMR, and the product was used in a subsequent reaction.

### Synthesis of OE2im

Production was performed with reference to Cellulose, 29, 3017-3024.

In order to synthesize diethylene glycol monomethylbenzenesulfonate, sodium hydroxide (2.5 equiv., 55 g, 1.38 mol) and the equal amount of water (55 g) were mixed, the resulting solution was added to a solution of diethylene glycol monomethyl ether (1 equiv., 60 g, 0.5 mol) in toluene (1000 mL), and diethylene glycol monomethyl ether was further added. A catalytic amount of benzyltrimethylammonium hydroxide (10 mL) was added, followed by stirring in an ice bath. Thereafter, benzene sulfonyl chloride (97 g, 0.6 mol) was dropwise added under stirring, followed by refluxing at 70° C. for 6 hours. After toluene was evaporated, the resulting solution was dissolved in dichloromethane, followed by washing once with water (3000 mL) and drying over sodium sulfate, thereby obtaining a product.

In order to synthesize 1-(2-(2-methoxyethoxy)ethyl)imidazole (OE2im), sodium hydroxide (2.5 equiv., 56.4 g, 1.4 mol) and the equal amount of water (57 g) were used to prepare an aqueous solution of sodium hydroxide. This base was added to a solution of imidazole (1 equiv., 32 g, 0.5 mol) in toluene (1000 mL), and subsequently a catalytic amount of benzyltrimethylammonium hydroxide (10 mL) was added. Thereafter, while cooling in an ice bath, diethylene glycol monomethylbenzenesulfonate (123 g, 0.5 mol) was slowly added and heated at 70° C. for 6 hours to obtain a colorless viscous liquid. After toluene was evaporated, distillation was performed under reduced pressure (1 Pa) at 160° C., thereby obtaining OE2im (yield: 92%). The structure of the product was confirmed by 1H NMR, and the product was used in a subsequent reaction.

### (3) Synthesis of oligoether imidazolium p-toluenesulfonate (3b)

The synthesized p-toluenesulfonyl PEG4 acid was placed in a 200 mL eggplant flask, and 40 mL of toluene was added for dissolution. Thereafter, 2.3 g of OE₂im was added, followed by stirring, and then, the resultant was reacted by refluxing using a reflux condenser at 80° C. for 27 hours. After 27 hours of refluxing, the reaction solution was dried under reduced pressure, and diethyl ether was added to the 200 mL eggplant flask containing the resulting product for washing (50 mL, 1 day, 3 times). After washing, drying was performed under reduced pressure to obtain a product. The structure of the product was confirmed by 1H NMR, and the product was used in a subsequent reaction.

### (4) Synthesis of oligoether imidazolium hydroxide (4b) and OE₂imC₂OE₃C

The synthesized imidazolium p-toluenesulfonate was dissolved in 400 mL of H₂O/MeOH (1/3: w/w) solvent, and the resulting mixture was transferred to a 1 L bottle. Thereafter, 27 mL, namely an excess amount, of anion exchange resin (Amberlite IRN-78, exchange capacity: 1.1 eq/L) was added, followed by stirring at room temperature for 10 days to produce oligoether imidazolium hydroxide.

Finally, OE2imC₂OE₃C was synthesized. After anion exchange, filter paper (5C, ADVANTEC) was used to remove the anion exchange resin, and the reaction solution was transferred to a 50 mL eggplant flask. The resulting reaction solution was concentrated, and the neutralization reaction and the production reaction of OE₂imC₂OE₃C were allowed to proceed. Thereafter, diethyl ether was added to the 50 mL eggplant flask containing the product for washing (30 mL, 1 day, 3 times). After washing, drying was performed under reduced pressure to obtain a liquid product. The purity was 98%, and the yield was about 50% relative to the tert-butyl 12-hydroxy-4,7,10-trioxadodecanoate.

¹H NMR (400 MHz; CDCl₃; Me₄Si) 6=2.428 (2H, t, J=10.8 Hz, CH₂COO), 3.354 (3H, s, CH₃OCH₂CH₂OCH₂CH₂N), 3.498-3.654 (6H, m, CH₃OCH₂CH₂OCH₂CH₂N and NCH₂CH₂OCH₂CH₂OCH₂CH₂OCH₂CH₂COO), 3.782 (2H, t, J=11.6 Hz, CH₃OCH₂CH₂OCH₂CH₂N), 3.875 (2H, t, J=9.6 Hz, NCH₂CH₂OCH₂CH₂OCH₂CH₂OCH₂CH₂COO), 4.474 (2H, t, J=9.6 Hz, NCH₂CH₂OCH₂CH₂OCH₂CH₂OCH₂CH₂COO), 4.563 (2H, t, J=9.2 Hz, NCH₂CH₂OCH₂CH₂OCH₂CH₂OCH₂CH₂COO), 7.242 and 7.395 (1H, m, NCHCHN), 10.659 (1H, s, NCHN).

Mass spectrometry with fast atom bombardment ionization: in positive mode m/z=375.2129 (M+H⁺, found) and 375.2131 (calculated); and in negative mode, m/z=373.1977 (M−H⁺ found) and 373.1975 (calculated).

### Synthesis Example 3 (Synthesis of C₂imOE₃C (R¹═C₂H₅, A=Imidazolium Cation, R²═CH₂CH₂, R³═CH₂CH₂, n=3, and B=—COO⁻))

### [Raw Materials]

Tert-butyl 12-hydroxy-4,7,10-trioxadodecanoate was purchased from Angene. p-Toluenesulfonyl chloride, sodium hydroxide, and diethyl ether were purchased from Tokyo Chemical Industry Co., Ltd. 1-Ethylimidazole, toluene, dichloromethane, methanol, chloroform-di, 99.8 atom % D with 0.03 vol % TMS, dimethyl sulfoxide-d₆ and 99.9 atom % D with 0.03 vol % TMS were purchased from Kanto Chemical Co., Inc. Hydrochloric acid was purchased from FUJIFILM Wako Pure Chemical Corporation. Amberlite IRN-78, ion exchange resin, nuclear grade was purchased from Alfa Aesar.

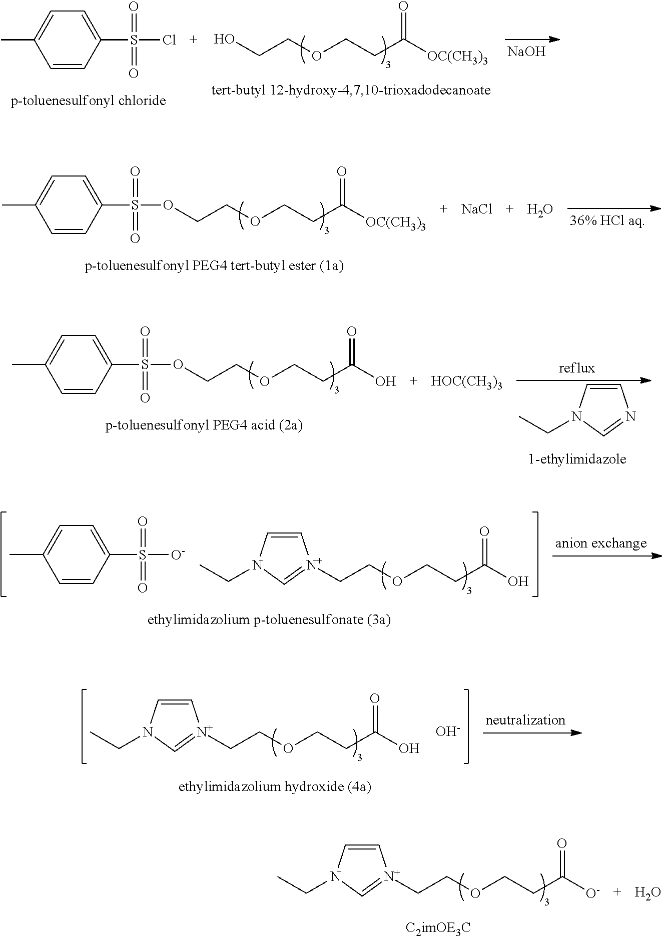

### (1) Synthesis of p-toluenesulfonyl PEG4 tert-butyl ester (1a)

3.7 g of tert-butyl 12-hydroxy-4,7,10-trioxadodecanoate was placed in a 50 mL eggplant flask, and 40 mL of dichloromethane (DCM) was added for dissolution. Thereafter, 3.8 g of NaOH was added to 6 equiv. (molar equivalent) with respect to the tert-butyl 12-hydroxy-4,7,10-trioxadodecanoate. Further, the eggplant flask was cooled with ice, and 5.0 g of p-toluenesulfonyl chloride was gradually dropwise added to 1.5 equiv. with respect to the tert-butyl 12-hydroxy-4,7,10-trioxadodecanoate. After dropping the entire amount, the mixture was reacted by stirring at room temperature for 34 hours, and filter paper (5C, ADVANTEC) was used to remove solid impurities. The reaction solution containing the filtered product was placed in a liquid separation funnel. Thereafter, water was added, the sodium concentration of the water layer was measured using a sodium concentration meter, and the liquid separation operation was performed until the measured sodium concentration was 0 ppm. After the liquid separation, the DCM layer was dried under reduced pressure to obtain p-toluenesulfonyl PEG4 tert-butyl ester (1a) (state: liquid).

### (2) Synthesis of p-toluenesulfonyl PEG4 acid (2a)

The p-toluenesulfonyl PEG4 tert-butyl ester was placed in a 200 mL eggplant flask, 9.0 g, namely an excess amount with respect to the p-toluenesulfonyl PEG4 tert-butyl ester, of 36% HCl aq. was added, and the resulting mixture was reacted by stirring at room temperature for 3 hours. The reaction solution containing the product was dissolved in DCM and placed in a liquid separation funnel. Thereafter, water was added, the pH was measured using pH test paper, and the liquid separation operation was performed until the pH of the water layer was 6. After the liquid separation, the DCM layer dried under reduced pressure was transferred to a 300 mL eggplant flask, and 100 mL, namely an excess amount, of water was added, followed by stirring at 60° C. for 1 hour to decompose unreacted p-toluenesulfonyl chloride. The reaction solution was dissolved in DCM and placed in a liquid separation funnel, water was added, the pH was measured using pH test paper, and the liquid separation operation was performed until the pH of the water layer was 6. After liquid separation, the DCM layer was dried under reduced pressure to obtain p-toluenesulfonyl PEG4 acid (2a) (state: liquid, yield: 20% of initial raw material input).

### (3) Synthesis of ethylimidazolium p-toluenesulfonate (3a)

The p-toluenesulfonyl PEG4 acid was placed in a 50 mL eggplant flask, and 10 mL of toluene was added for dissolution. Further, the eggplant flask was cooled with ice, and 0.27 g of 1-ethylimidazole was gradually dropwise added to 1.05 equiv. with respect to the p-toluenesulfonyl PEG4 acid. After dropping the entire amount, the resulting mixture was reacted using a reflux condenser at 80° C. for 20 hours, and separated into an upper layer containing unreacted materials and a lower layer containing the product. The upper layer was discarded by decantation, and the lower layer containing the product was washed with diethyl ether (20 mL, 1 h, 3 times). After washing, drying was performed under reduced pressure to obtain ethylimidazolium p-toluenesulfonate (3a) (state: liquid).

### (4) Synthesis of ethylimidazolium hydroxide (4a) and CzimOE₃C

The ethylimidazolium p-toluenesulfonate was placed in a 110 mL vial, and 70 mL of methanol was added for dissolution. Further, 9 mL of strong anion exchange resin Amberlite IRN-78 (exchange capacity: 1.1 eq./L) was added, followed by stirring at room temperature for 5 days to produce ethylimidazolium hydroxide (4a). The reaction solution was concentrated in a 50 mL flask, and the neutralization reaction was allowed to proceed. Thereafter, diethyl ether was added to the eggplant flask containing the product for washing (20 mL, 30 min, 3 times). After washing, drying was performed under reduced pressure to obtain C₂imOE₃C (state: liquid).

CzimOE3C: ¹H NMR (400 MHz; DMSO; Me₄Si) δ=1.380 (3H, t, J=7.4 Hz, NCH₂CH₃), 1.970 (2H, t, J=7.0 Hz, CH₂COO), 3.325-3.497 (10H, m, NCH₂H₂OCH₂CH₂OCH₂CH₂OCH₂CH₂COO), 3.750 and 4.320 (2H, t, J=both 5.0 Hz, NCH₂CH₂OCH₂), 4.199 (2H, q, NCH₂CH₃), 7.747 and 7.826 (1H, m, NCHCHN), 9.613 (1H, s, NCHN).

### Synthesis Example 4 (Synthesis of AimOE₃C (R¹=—CH₂—CH═CH₂, A=imidazolium cation, R¹ ═CH₂CH₂, R³═CH₂CH₂, n=3, and B=—COO⁻))

### [Raw Materials]

Tert-butyl 12-hydroxy-4,7,10-trioxadodecanoate was purchased from Angene. p-Toluenesulfonyl chloride, sodium hydroxide, and diethyl ether were purchased from Tokyo Chemical Industry Co., Ltd. 1-Allylimidazole, toluene, dichloromethane, methanol, chloroform-di, 99.8 atom % D with 0.03 vol % TMS, dimethyl sulfoxide-d₆ and 99.9 atom % D with 0.03 vol % TMS were purchased from Kanto Chemical Co., Inc. Hydrochloric acid was purchased from FUJIFILM Wako Pure Chemical Corporation. Amberlite IRN-78, ion exchange resin, nuclear grade was purchased from Alfa Aesar.

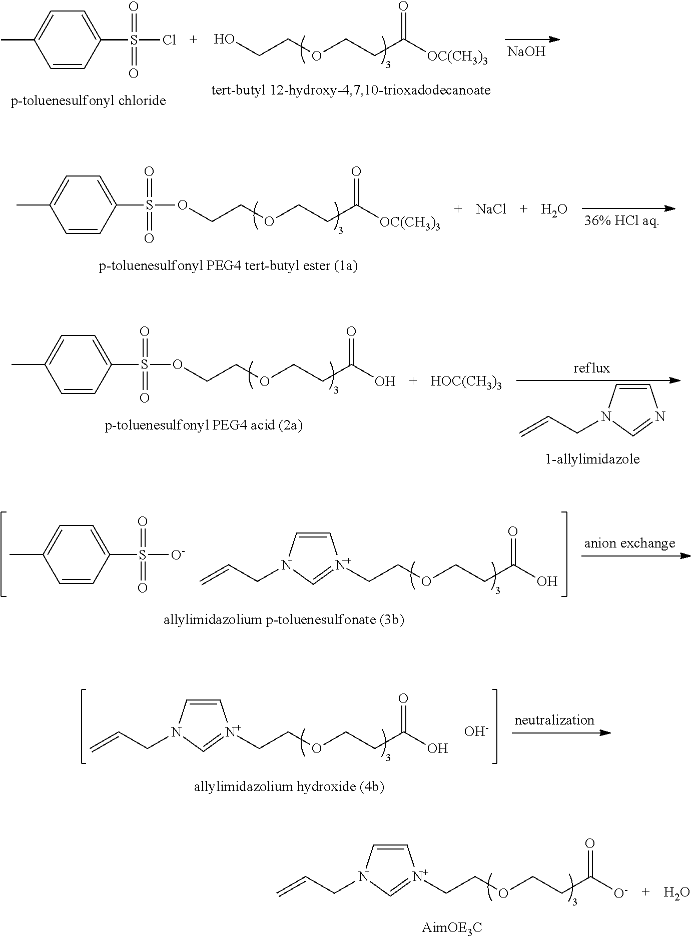

### (1) Synthesis of p-toluenesulfonyl PEG4 tert-butyl ester (1a)

3.0 g of tert-butyl 12-hydroxy-4,7,10-trioxadodecanoate was placed in a 50 mL eggplant flask, and 30 mL of DCM was added for dissolution. Thereafter, 1.6 g of NaOH was added to 3.7 equiv. (molar equivalent) with respect to the tert-butyl 12-hydroxy-4,7,10-trioxadodecanoate. Further, the eggplant flask was cooled with ice, and 2.6 g of p-toluenesulfonyl chloride was gradually dropwise added to 1.3 equiv. with respect to the tert-butyl 12-hydroxy-4,7,10-trioxadodecanoate. After dropping the entire amount, the mixture was reacted by stirring at room temperature for 24 hours, and filter paper (5C, ADVANTEC) was used to remove solid impurities. The reaction solution containing the filtered product was placed in a liquid separation funnel. Thereafter, water was added, the sodium concentration of the water layer was measured using a sodium concentration meter, and the liquid separation operation was performed until the measured sodium concentration was 0 ppm. After liquid separation, the DCM layer was dried under reduced pressure to obtain p-toluenesulfonyl PEG4 tert-butyl ester (1a) (state: liquid).

### (2) Synthesis of p-toluenesulfonyl PEG4 acid (2a)

The p-toluenesulfonyl PEG4 tert-butyl ester was placed in a 200 mL eggplant flask, 9.0 g, namely an excess amount with respect to the p-toluenesulfonyl PEG4 tert-butyl ester, of 36% HCl aq. was added, and the resulting mixture was reacted by stirring at room temperature for 3 hours. The reaction solution containing the product was dissolved in DCM and placed in a liquid separation funnel. Thereafter, water was added, the pH was measured using pH test paper, and the liquid separation operation was performed until the pH of the water layer became 6. After the liquid separation, the DCM layer dried under reduced pressure was transferred to a 300 mL eggplant flask, and 100 mL, namely an excess amount, of water was added, followed by stirring at 60° C. for 1 hour to decompose unreacted p-toluenesulfonyl chloride. The reaction solution was dissolved in DCM and placed in a liquid separation funnel, water was added, the pH was measured using pH test paper, and the liquid separation operation was performed until the pH of the water layer became 6. After the liquid separation, the DCM layer was dried under reduced pressure to obtain p-toluenesulfonyl PEG4 acid (2a) (state: liquid, yield: 39% of initial raw material input).

### (3) Synthesis of allylimidazolium p-toluenesulfonate (3b)

1.16 g of the p-toluenesulfonyl PEG4 acid was placed in a 50 mL eggplant flask, and 10 mL of toluene was added for dissolution. Further, the eggplant flask was cooled with ice, and 0.36 g of 1-allylimidazole was gradually dropwise added to 1.1 equiv. with respect to the p-toluenesulfonyl PEG4 acid. After dropping the entire amount, the resulting mixture was reacted using a reflux condenser at 80° C. for 21 hours, and separated into an upper layer containing unreacted materials and a lower layer containing the product. The upper layer was discarded by decantation, and the lower layer containing the product was washed with diethyl ether (20 mL, 1 h, 3 times). After washing, drying was performed under reduced pressure to obtain allylimidazolium p-toluenesulfonate (3b) (state: liquid).

### (4) Synthesis of allylimidazolium hydroxide (4b) and AimOE₃C

The allylimidazolium p-toluenesulfonate was placed in a 110 mL vial, and 80 mL of methanol was added for dissolution. Further, 11 mL of strong anion exchange resin Amberlite IRN-78 (exchange capacity: 1.1 eq./L) was added, followed by stirring at room temperature for 6 days to produce allylimidazolium hydroxide (4b). The reaction solution was concentrated in a 50 mL flask, and the neutralization reaction was allowed to proceed. Thereafter, diethyl ether was added to the eggplant flask containing the product for washing (20 mL, 30 min, 3 times). After washing, drying was performed under reduced pressure to obtain AimOE₃C (state: liquid)

AimOE₃C: 1H NMR (400 MHz; DMSO; Me₄Si) δ=2.009 (3H, t, J=7.0 Hz, CH₂COO), 3.390-3.548 (10H, m, NCH₂CH₂OCH₂CH₂OCH₂CH₂OCH₂CH₂COO), 3.797 and 4.380 (2H, t, J=5.0 and 4.8 Hz, NCH₂CH₂OCH₂), 4.915 (2H, d, NCH₂CHCH₂), 5.249-5.357 (2H, m, NCH₂CHCH₂), 6.016-6.114 (1H, m, NCH₂CHCH₂), 7.775 and 7.823 (1H, m, NCHCHN), 9.656 (1H, s, NCHN).

### Synthesis Example 5 (Synthesis of VimOE₃C (R¹=—CH═CH₂, A=Imidazolium Cation, R²═CH₂CH₂, R³═CH₂CH₂, n=3, and B=—COO⁻) Precursor-vinylimidazolium p-toluenesulfonate)

### [Raw Materials]

Tert-butyl 12-hydroxy-4,7,10-trioxadodecanoate was purchased from Angene. p-Toluenesulfonyl chloride, sodium hydroxide and diethyl ether were purchased from Tokyo Chemical Industry Co., Ltd. 1-Vinylimidazole, toluene, dichloromethane, methanol, chloroform-di, 99.8 atom % D with 0.03 vol % TMS, dimethyl sulfoxide-d₆ and 99.9 atom % D with 0.03 vol % TMS were purchased from Kanto Chemical Co., Inc. Hydrochloric acid was purchased from FUJIFILM Wako Pure Chemical Corporation. Amberlite IRN-78, ion exchange resin, nuclear grade was purchased from Alfa Aesar.

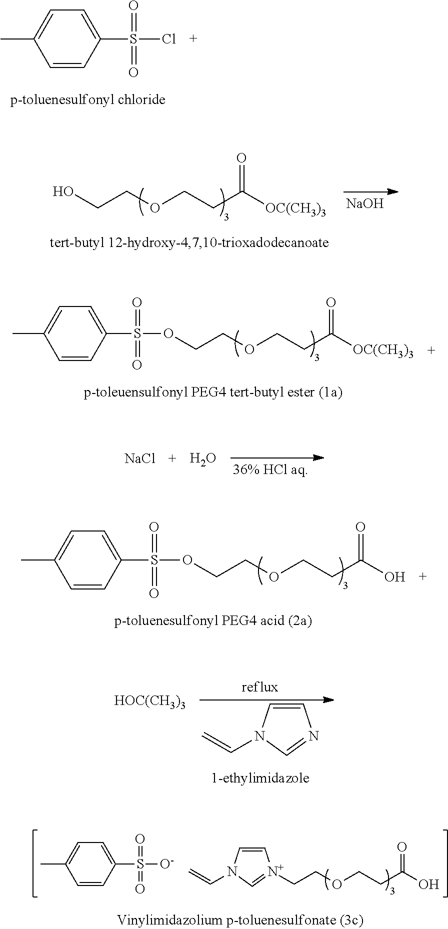

### (1) Synthesis of p-toluenesulfonyl PEG4 tert-butyl ester (1a)

3.0 g of tert-butyl 12-hydroxy-4,7,10-trioxadodecanoate was placed in a 50 mL eggplant flask, and 30 mL of DCM was added for dissolution. Thereafter, 1.6 g, namely 3.7 equiv. (molar equivalent) with respect to the tert-butyl 12-hydroxy-4,7,10-trioxadodecanoate, of NaOH was added. Further, the eggplant flask was cooled with ice, and 2.6 g, namely 1.3 equiv. with respect to the tert-butyl 12-hydroxy-4,7,10-trioxadodecanoate, of p-toluenesulfonyl chloride was gradually dropwise added. After dropping the entire amount, the resulting mixture was reacted by stirring at room temperature for 24 hours, and filter paper (5C, ADVANTEC) was used to remove solid impurities. The reaction solution containing the filtered product was placed in a liquid separation funnel. Thereafter, water was added, the sodium concentration of the water layer was measured using a sodium concentration meter, and the liquid separation operation was performed until the measured sodium concentration became 0 ppm. After the liquid separation, the DCM layer was dried under reduced pressure to obtain p-toluenesulfonyl PEG4 tert-butyl ester (1a) (state: liquid).

### (2) Synthesis of p-toluenesulfonyl PEG4 acid (2a)

The p-toluenesulfonyl PEG4 tert-butyl ester was placed in a 200 mL eggplant flask, 9.0 g, namely an excess amount, of 36% HCl aq. was added to the p-toluenesulfonyl PEG4 tert-butyl ester, and the resulting mixture was reacted by stirring at room temperature for 3 hours. The reaction solution containing the product was dissolved in DCM and placed in a liquid separation funnel. Thereafter, water was added, the pH was measured using pH test paper, and the liquid separation operation was performed until the pH of the water layer became 6. After the liquid separation, the DCM layer dried under reduced pressure was transferred to a 300 mL eggplant flask, and 100 mL, namely an excess amount, of water was added, followed by stirring at 60° C. for 1 hour to decompose unreacted p-toluenesulfonyl chloride. The reaction solution was dissolved in DCM and placed in a liquid separation funnel, water was added, the pH was measured using pH test paper, and the liquid separation operation was performed until the pH of the water layer became 6. After the liquid separation, the DCM layer was dried under reduced pressure to obtain p-toluenesulfonyl PEG4 acid (2a) (state: liquid, yield: 39% of initial raw material input).

### (3) Synthesis of vinylimidazolium p-toluenesulfonate (3c)

0.5 g of the p-toluenesulfonyl PEG4 acid was placed in a 50 mL eggplant flask, and 10 mL of toluene was added for dissolution. Further, the eggplant flask was cooled with ice, and 0.15 g, namely 1.2 equiv. with respect to the p-toluenesulfonyl PEG4 acid, of 1-vinylimidazole was gradually dropwise added. After dropping the entire amount, the resulting mixture was reacted using a reflux condenser at 80° C. for 17 hours, and separated into an upper layer containing unreacted materials and a lower layer containing the product. The upper layer was discarded by decantation, and the lower layer containing the product was washed with diethyl ether (20 mL, 1 h, 3 times). After washing, drying was performed under reduced pressure to obtain vinylimidazolium p-toluenesulfonate (3b) (state: liquid).

Vinyliimidazolium p-toluenesulfonate: ¹H NMR (400 MHz; DMSO; Me₄Si) δ=2.286 (3H, s, CHCCH₃), 2.430 (2H, t, J=6.4, CH₂COOH), 3.465-3.631 (10H, m, NCH₂CH₂OCH₂CH₂OCH₂CH₂OCH₂CH₂COOH), 3.798 and 4.379 (2H, t, J=both 5.0 Hz, NCH₂CH₂OCH₂), 5.431 (1H, dd, J=2.8 and 2.4 Hz, NCHCH₂), 5.963 (1H, dd, J=both 2.4 Hz, NCHCH₂), 7.121 and 7.490 (2H, d, J=both 7.6 Hz, SO₂CHCHCCH₃CHCH), 7.274-7.350 (1H, m, NCHCH₂), 7.880 and 8.199 (1H, m, NCHCHN), 9.408 (1H, s, NCHN), 12.181 (1H, s, CH₂COOH).

### Synthesis Example 6 (Synthesis of C₁imC₃P (R¹═CH₃, A=imidazolium cation, R²═(CH₂) 3, n=0, and B=—P (═O) (O₂H₅) O⁻))

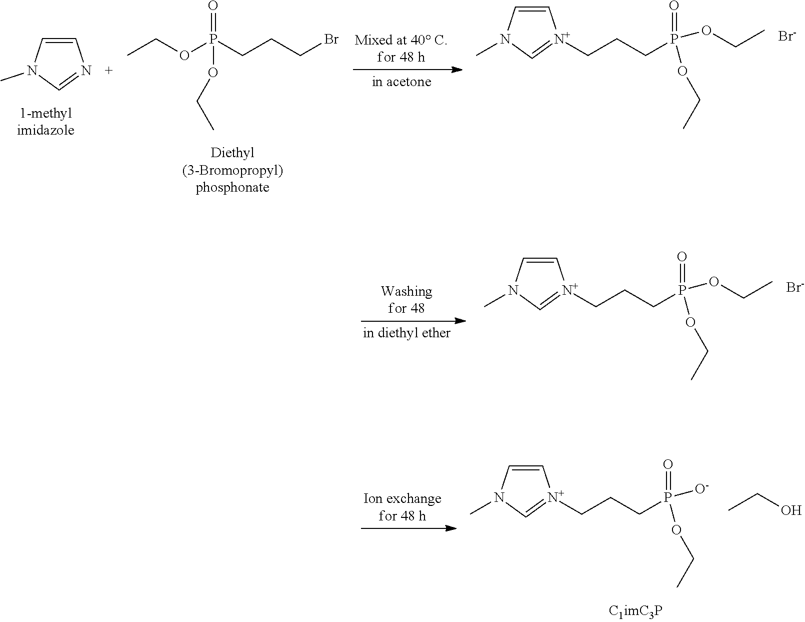

1-Methylimidazole and diethyl (3-bromopropyl)phosphonate were used to synthesize C₁imC₃P. The raw materials were reacted at 40° C. for 48 hours using acetone as a solvent, thereby synthesizing an intermediate of C imC₃P. Thereafter, the intermediate was washed with diethyl ether, followed by ion-exchange.

### Synthesis Example 7 (Synthesis of C₁imC₂P (R¹═CH₃, A=imidazolium cation, R²═(CH₂)₂, n=0, and B=—OP (═O) (O₂H)⁻))

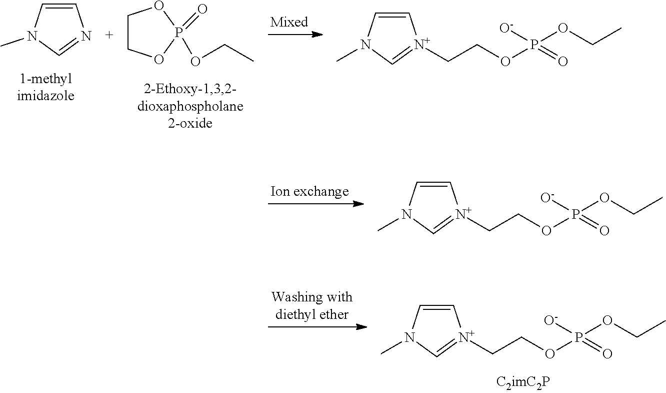

Synthesis was performed using 1-methylimidazole and 2-ethoxy-2-oxo-1,3,2-dioxophosphorane, which is cyclic phosphoric acid, as raw materials. The raw materials were used at a ratio of 2:1 in the absence of a solvent and reacted at 27° C. for 48 hours to synthesize C₁imC₂P. The synthesized C₁imC₂P was diluted with water, and mixed and stirred with an anion exchange resin (Amberlite IRN 78, hydroxide form). The anion exchange resin was removed by filtration, and water was distilled off under reduced pressure. Then, the resultant was washed with an excess amount of diethyl ether, thereby synthesizing C₁imC₂P with high purity. The purity was confirmed from the results of ¹H NMR, mass spectrometry, and elemental analysis.

### Mass Spectrometry

[M+H]⁺ 233.0695 (measured value), 233.0686 (theoretical value) [M−H]⁻ 235.0847 (measured value), 235.0842 (theoretical value)

### Elemental Analysis

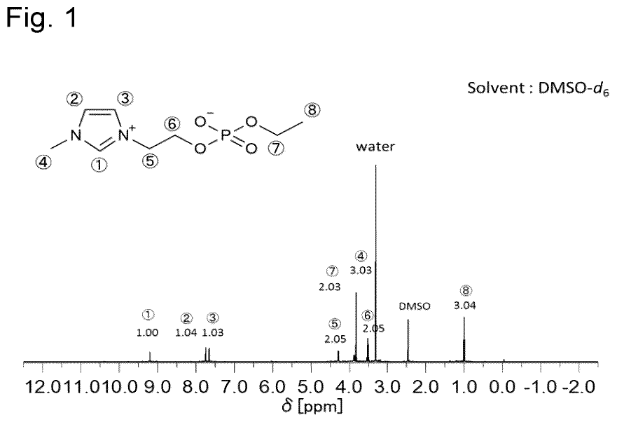

C₁imC₂P·1.9H₂O (measured value: C, 35.95; H, 7.06; N, 10.17; theoretical value C₈H_{18.8}N₂O_{5.9}: C, 35.80; H, 7.06; N, 10.44%)
   FIG. 1 shows the 1H NMR chart.

### Test Example 1

C₁imC₂OE₃C (R¹═CH₃, A=imidazolium cation, R³═CH₂CH₂, n=3, and B=—COO⁻) obtained in Synthesis Example 1 and OE₂imC₂OE₃C(R¹═H₃C(OCH₂CH₂)₂, A=imidazolium cation, R³═CH₂CH₂, n=3, and B=—COO⁻) obtained in Synthesis Example 2 were both liquid at room temperature (25° C.).

C₁imC₂OE₃C obtained in Synthesis Example 1 was heated at a rate of 10° C./min, and the temperature at which the weight loss occurred (pyrolysis temperature) was measured. As a result, this compound was thermally decomposed at about 249° C. and was stable up to 249° C.

### Test Example 2

C₁imC₂OE₃C obtained in Synthesis Example 1 was subjected to differential scanning calorimetry. As a result, it was revealed that this compound did not change up to around 250° C. and was in a liquid state at from room temperature to around 250° C.

### Test Example 3

C₁imC₂OE₃C obtained in Synthesis Example 1 and OE₂imC₂OE₃C obtained in Synthesis Example 2 were measured for viscosity at 80° C. The viscometer used was Brookfield LVDV2TCP with a CPE52 spindle. The viscometer was heated to 80° C. by passing warm water therethrough, and the viscosity of the samples was measured.

### Test Example 4

The cellulose solubility of C₁imC₂OE₃C obtained in Synthesis Example 1, OE₂imC₂OE₃C obtained in Synthesis Example 2, and OE₂imC₃C (R¹═H₃C(OCH₂CH₂)₂, A=imidazolium cation, B=—COO⁻, and n=0 (a compound having no oxyalkylene structure between the cationic and anionic moieties; the compound described in Non-Patent Literature 2)) as a comparative example was measured. As for the cellulose solubility, cellulose (Avisel) was added while increasing the concentration from 1 wt. %, followed by heating and stirring at 120° C. for 1 hour. The concentration at which cellulose dissolution was confirmed was visually measured.

Table 2 shows the results of Test Examples 3 and 4 and the state of the zwitterions at 25° C.

TABLE 2

| | | | Cellulose | |
|---|---|---|---|---|
| | State | Viscosity at | solubility (wt %) | |
| Zwitterion | at 25° C. | 80° C. (mPa · s) | 100° C. | 120° C. |
| OE₂imC₃C²³ | solid | 940 | 6 | 10 |
| OE₂imC₂OE₃C | liquid | 810 | 11 | 11 |
| C₁imC₂OE₃C | liquid | 2,500 | 11 | 14 |

It is evident from Table 2 that the zwitterion of the present invention is useful as a plant cell wall-dissolving agent, because the zwitterion of the present invention is liquid at room temperature, has low viscosity and can dissolve high concentrations of cellulose.

### Test Example 5

The cellulose solubility of C₁imC₂P was examined.

100 wt % C₁imC₂P is liquid at room temperature (25° C.), but has very high viscosity. Thus, when heating to 80° C., a stirrer rotated in C₁imC₂P and started to rotate smoothly at 120° C. Accordingly, a cellulose solubility experiment was performed at 120° C. Avicel was added in increments of 1 wt %, and when dissolved over 1 hour, additional Avicel was added in increments of 1 wt %. As a result of the experiment, C₁imC₂P dissolved 4 wt % Avicel.

### Test Example 6 (Cytotoxicity of C₁imC₂P)

The toxicity of C₁imC₂P to yeast was examined. The yeast used was Kluyveromyces marxianus. C₁imC₂P was added to a liquid medium at concentrations of 0 mol/L, 0.01 mol/L, 0.05 mol/L, 0.1 mol/L, 0.5 mol/L and 1.0 mol/L respectively. This was inoculated with bacteria, and while culturing at 50° C., OD₆₀₀ was measured with a plate reader 0, 2, 4, and 6 hours later. OD₆₀₀ indicates the density of bacterial cells. Further, relative OD₆₀₀ is a relative parameter when the control is 1.00. A higher value of relative OD₆₀₀ indicates a lower toxicity of the zwitterion. The relative OD₆₀₀ of C₁imC₂P was 0.77, indicating low toxicity.

1. A zwitterion of formula (1): 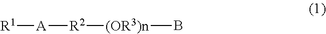
wherein
R¹ represents a linear alkyl group having from 1 to 8 carbon atoms, an alkenyl group having from 2 to 8 carbon atoms, or a C₁₋₈ linear-alkyl-(OCH₂CH₂)m-,
A is a cationic moiety of the zwitterion and represents a cation selected from the group consisting of imidazolium cation, phosphonium cation, sulfonium cation, pyrazolium cation, pyrrolidinium cation, morpholinium cation, cyclopropenium cation, and piperidinium cation,
R² represents an alkylene group having from 1 to 4 carbon atoms,
R³ represents an alkylene group having from 2 to 4 carbon atoms,
m represents a number of 1 or 2,
n represents a number from 0 to 10, and
B represents an anion selected from the group consisting of —SO₃⁻, —COO—, —P═O(OR⁴)O⁻, and —OP═O(OR⁵)O⁻, wherein R⁴ and R⁵ are the same or different and are each a hydrogen atom or an alkyl group having from 1 to 8 carbon atoms and optionally having a heteroatom, with the proviso that when n is 0, B is —P═O(OR⁴)O⁻ or —OP═O(OR⁵)O⁻.

2. The zwitterion according to claim 1, wherein A in formula (1) is a cation selected from the group consisting of imidazolium cation, pyrazolium cation, pyrrolidinium cation, and piperidinium cation.

3. The zwitterion according to claim 1, wherein A in formula (1) is imidazolium cation.

4. The zwitterion according to claim 1, wherein R¹ in formula (1) represents a linear alkyl group having from 1 to 4 carbon atoms, an alkenyl group having from 2 to 4 carbon atoms, or a C₁₋₄ alkyl-(OCH₂CH₂)m- wherein m represents a number of 1 or 2.

5. The zwitterion according to claim 1, wherein n in formula (1) is a number from 1 to 6.

6. The zwitterion according to claim 1, wherein B in formula (1) is —COO⁻.

7. The zwitterion according to claim 1, wherein n in formula (1) is a number from 0 to 6, and B is —P═O(OR⁴)O⁻ or —OP═O(OR⁵)O⁻.

8. A plant cell wall-dissolving agent composition comprising the zwitterion according to claim 1.

9. A cellulose-dissolving agent composition comprising the zwitterion according to claim 1.

10. A method for dissolving cell walls of a plant, comprising:
contacting a composition comprising the zwitterion according to claim 1 with the plant.

11. A method for dissolving cellulose in a cellulose-containing plant, comprising:
contacting a composition comprising the zwitterion according to claim 1 with the plant.
